(19) United States
(12) Patent Application Publication
(10) Pub. No.: US 2004/0113926 A1
(43) Pub. Date: Jun. 17, 2004

(54) Method and apparatus for the detection of the effective number of gray levels of a display when showing motion images

(75) Inventor: Ming-Jiun Liaw, Hsinchu (TW)

Correspondence Address: BACON & THOMAS, PLLC, 625 SLATERS LANE, FOURTH FLOOR, ALEXANDRIA, VA, 22314

(73) Assignee: Industrial Technology Research Institute, Hsinchu (TW)

(21) Appl. No.: 10/673,200

(22) Filed: Sep. 30, 2003

(30) Foreign Application Priority Data
Dec. 16, 2002 (TW) 091136324

(51) Int. Cl. G09G 5/10

(52) U.S. Cl. 345/690; 348/180; 345/89

(57) ABSTRACT

An image processing method and apparatus discloses for determining the number of gray levels of a display while showing motion images. The method and the apparatus utilize either a real human eye or a visual simulator which simulates human eye's detection behaviors to determine discriminations of gray levels. The invention features that generating a still image and a motion image which is the duplication of the still image but having moving speed and direction and then showing them on the interested display together to provide real human eyes or the above-mention human eye simulator for detecting the number of gray levels of the moving image. Gray levels of a display while showing moving images are judged as not lost if edge of adjacent gray levels of the moving image can be discriminated by human eyes or the human eye simlator.

### FIELD OF THE INVENTION

The present invention relates to a method and to an image apparatus for detecting the effective number of gray levels of a display while showing motion images. The method and the apparatus utilizes either a real human eye or a visual simulator which simulates human eye's detection behaviors to determine the actual number of gray levels which can be really discriminated by human eyes. The invention features that first generating a still image pattern and a motion image pattern, which is the duplication of the still image but having a motion vector, and then showing the two images on the interested display at the same time to provide real human eyes or the above-mentioned human eye simulator for detecting the effective number of gray levels of the interested display.

### BACKGROUND OF THE INVENTION

Traditionally, a common method for measuring contrast of LCDs is to measure the brightness values of full-white and full-black images. In the method, the brightness values are measured after LC molecules are fully responded to the applied electrical potentials. In other words, the LC molecules already reach dynamic equipment state. While that is usually not the case for LC molecules when showing moving pictures. FIG. 1 shows the difference of contrast of an interested LCD when showing still images and motion pictures. In this figure, there is a time axis (100) showing four sequent frames, which are the 1st frame (101), the 2nd frame (102), the 3rd frame (103), and the 4th frame (104). The line 111 indicates the brightness transition from dark to white when the measurement of contrast of an interested LCD is conducted. As shown in FIG. 1, the transition spends 4 frames, for example, reaching dynamic equipment state because of slow response of LC molecules. The brightness of the dark image is measured before the 1^{st} frame. Then, the LCD changes images from full-dark image to full-white one. The brightness of the white image is measured after LC molecules fully response to the applied potential, that is at the frame after 4^{th} frame. The brightness difference between the dark and white images is indicated by the line 113.

When the LCD shows a series alternative black-white images, the LC molecules don't have plenty of time to fully response the alternative driving voltages. Then the brightness transition of the LCD will like what indicated by line 112. At the beginning of frame 101, the LCD changes images from a full-black to a full-white; and the LC molecules response the changes of driving voltages, making the brightness higher and higher. At the end of frame 101, which LC molecules still don't fully response to the driving voltages, resulting in the brightness level is still lower than its target value of white images, the LCD changes its image from white to black; then the LC molecules also response, even very slow, to the changes of driving voltages, making the brightness decreases as time. At the end of frame 102, which LC molecules still don't fully response to the driving voltages, resulting in the brightness level is still higher than its target value of black images, the LCD changes its image from black to white; then the LC molecules also response, even very slow, to the changes of driving voltages, making the brightness increases as time. As a result, the contrast range (114) of an LCD when showing alternative black-white images is obviously less than its contrast range (113) when it shows still images.

To measure the performance of LCDs when showing moving images, the present invention relates to a method and to an image apparatus for detecting the effective number of gray levels of a display while showing motion images.

### SUMMARY OF THE INVENTION

The present invention relates to a method and to an image apparatus for detecting the effective number of gray levels of a display while showing motion images. The method and the apparatus utilize either a real human eye or a visual simulator which simulates human eye's detection behaviors to determine the effective number of gray levels. The invention features that first generating a still image pattern and a motion image pattern, which is the duplication of the still image but having a motion vector, and then showing the two images on the interested display at the same time to provide real human eyes or the above-mentioned human eye simulator for detecting the effective number of gray levels of the interested display. The edge between any two adjacent gray levels of the moving image is treated as the criteria to judge whether or not the gray levels of a display while showing moving images are lost.

The present invention may best be understood through the following description with reference to the accompanying drawings:

### BRIEF DESCRIPTION OF THE DRAWINGS

FIG. 1 is an explanatory view of a prior art in LCD field showing the contrast difference when a LCD showing still images and moving pictures;

FIG. 2A is a preferred embodiment showing a method and an apparatus utilizing real human eyes to determine the effective number of gray levels of a display while showing motion images.;

FIG. 2B is a preferred embodiment showing a method and an apparatus utilizing visual simulator to determine the effective number of gray levels of a display while showing motion images.;

FIG. 3A is an explanatory view spatially showing monochromatically increasing physical brightness levels;

FIG. 3B is an explanatory view showing actually visual brightness perception referring to FIG. 3A;

FIG. 4A is a schematic example spatially showing non-monochromatically increasing physical brightness levels;

FIG. 4B is an explanatory view showing actually visual brightness perception referring to FIG. 4A; and

FIG. 5 is a preferred embodiment showing an image method and an apparatus for determine whether or not the gray levels monochromatically change when LCDs are showing motion pictures.

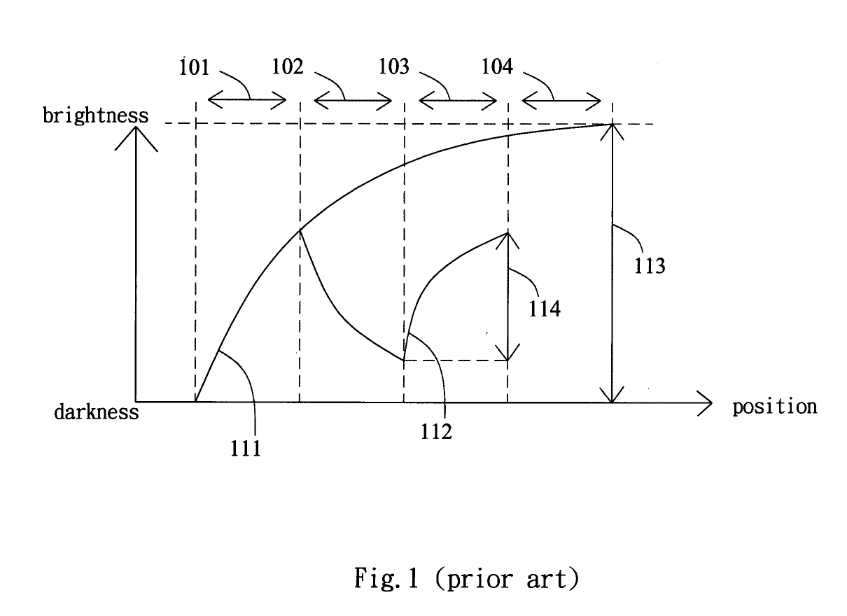

### DETAILED DESCRIPTION OF THE PREFERRED EMBODIMENTS

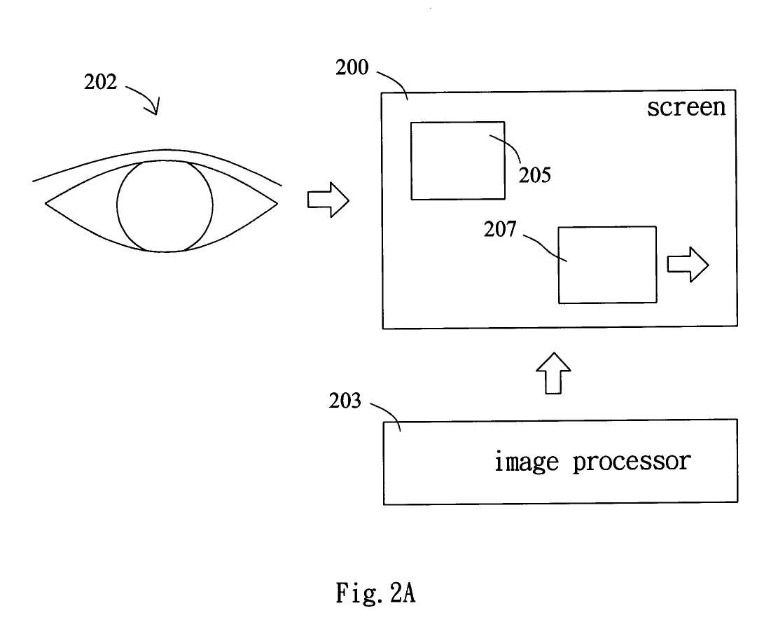

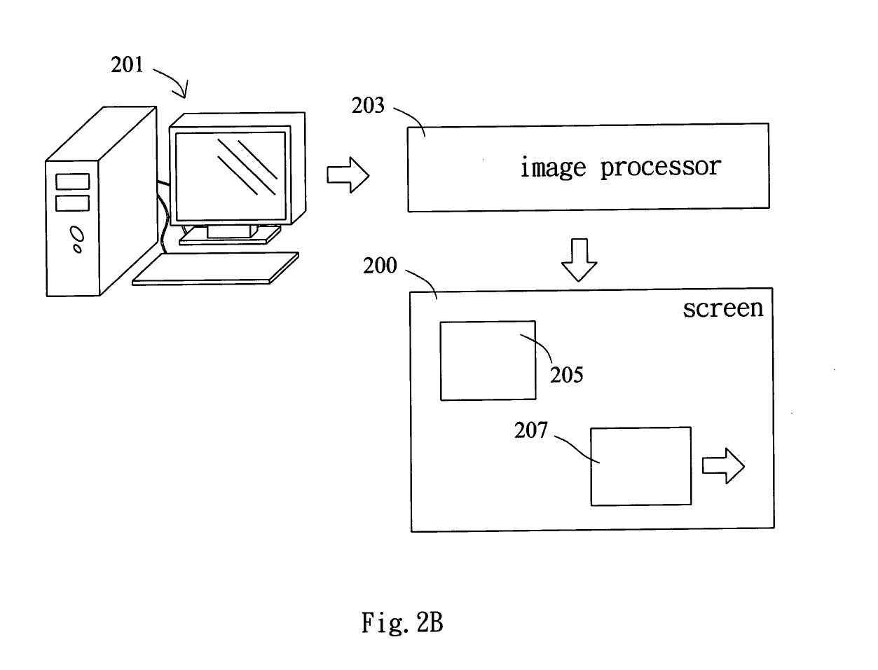

FIG. 2A is a preferred embodiment showing a method and an apparatus utilizing real human eyes to determine the effective number of gray levels of a display while showing motion images. The screen (200) of the interested LCD as shown in the figure displays two images by a image generating apparatus. One image is a still image (205) as a reference, and the other is its duplicated image (207) while with adjustable motion vectors.

The image generating means (203) generates a still image (205) and its duplicate image (207) with adjustable motion vector (including speed and direction) on the interested screen (200). The effective number of gray levels of interested LCDs while showing moving images is determined by judging the enhanced characteristic in the edges of the neighboring grayness zones. The judgment can be conducted by either real human eyes or a human visual simulator, or both. If the judgment is conducted by a human visual simulator, the embodiment of this invention is like that shown in FIG. 2B. The visual simulator is an apparatus which simulates the functions of a human real eyes sensory and recognition abilities. The said apparatus can be a computer with calculation algorithm. The visual effects such as brightness, color-ness, and reaction speed and etc. can be simulated by computer programming.

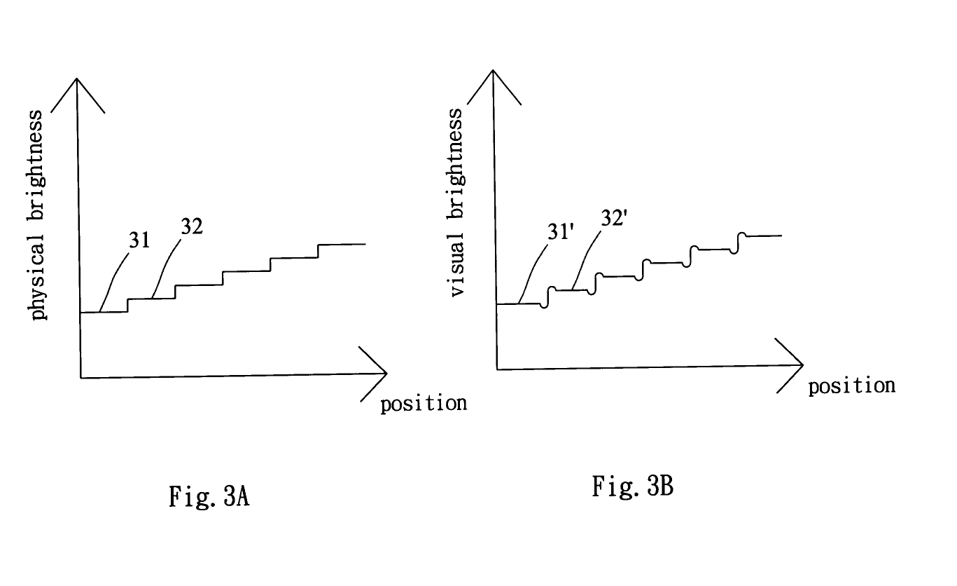

FIG. 3A spatially shows monochromatically increasing physical brightness levels. The brightness levels presenting here monochromatically increase step by step. However, in human visual perception, the edge between any two adjacent gray levels has larger-than-physical-brightness differences. If the brightness of the 1st gray level is close to that of the 2nd gray level, the edge contrast will be enhanced by human's visual system, resulting in the phenomena corresponds to FIG. 3B. As shown in this figure, the edge contrast between the 1st visual grayness level (31′) and the 2nd visual grayness (32′) is enhanced. Therefore, if the edge of neighboring zones can be still recognized when the interested LCD showing the moving image, its effective number of gray levels for moving images is regarded as not lost. In such case, the effective number of gray levels for moving images is regarded as the same as the effective number of gray levels for still images. On the contrary, if the edge of the moving image disappears and presents smooth, the effective number of gray levels for moving images of the interested LCD is less than that for showing still images.

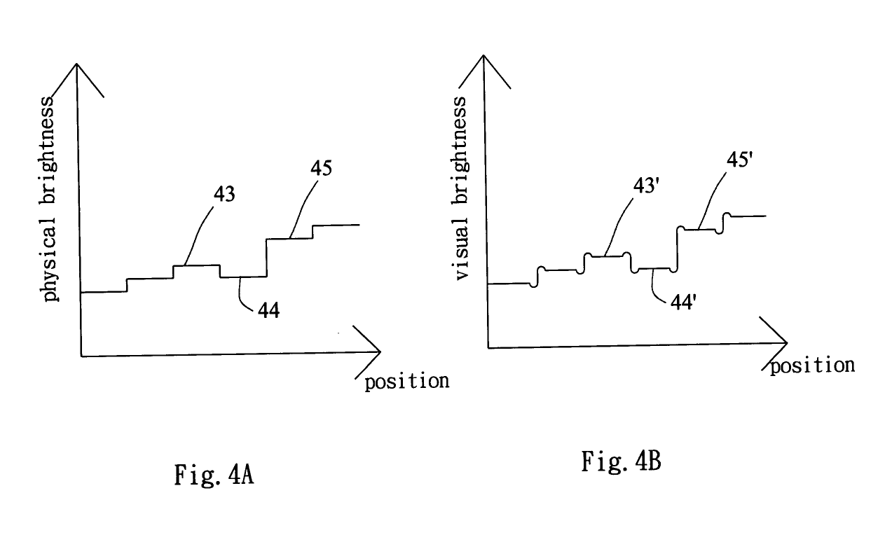

As shown in FIG. 4A, it is a schematic example spatially showing non-monochromatically increasing physical brightness levels. Physically, the image do not monochromatically increase as same as the image shown in FIG. 3A, but the edge contrast is still enhanced in vision. As shown in FIG. 4A, the brightness of the 3rd grayn level (43) and that of the 5^{th} gray level (45) are both higher than that of the 4^{th} gray level (44). However, the edge herein has been enhanced in visual contrast as same as the boundaries between 3 and 4, and 4 and 5 as shown in FIG. 4B. If the above physical brightness has an extremely little change, the visual sensory ability might not recognize as either a monochromatic increase/decrease or not. To overcome the drawback, this invention provides another embodiment.

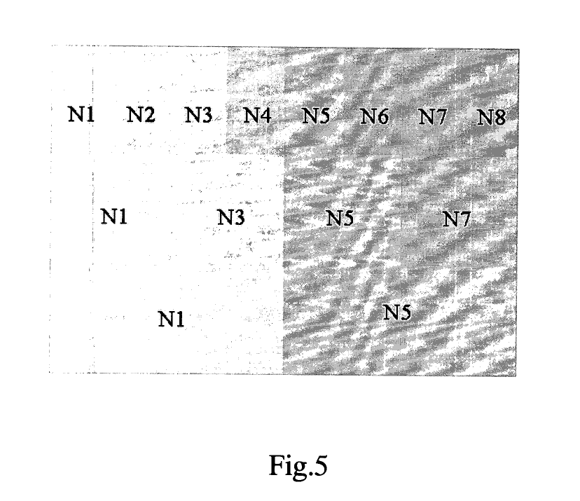

Please referring to the FIG. 5, the preferred embodiment shows an image generating method to determine whether or not the gray levels are monochromatically increasing. The method present interested gray levels with at least two ways at the same time. The first is present interested gray levels in each step, the other is to present these gray levels every two steps. If brightness difference between every two steps is not significant to distinguish whether they are monochromatic changes or not, every three, or four, and so on, can be used. As shown in FIG. 5, there are 8 gray levels in the upper row which are the 1st gray level (N1), the 2nd gray level (N2), the 3rd gray level (N3), the 4th gray level (N4), the 5th gray level (N5), the 6th gray level (N6), the 7th gray level (N7), and the 8th gray level (N8) arranging from the left to the right. If the change of the physical brightness between any two adjacent gray levels of these gray levels is small, the gray levels, at the same time, can be further extracted and shown by every two gray levels as shown in the 2nd row, which are the 1st gray level (N1), the 3rd gray level (N3), the 5th gray level (N5), and the 7 gray level (N7); or another selected arrangement which are 2nd gray level (N2), 4th gray level (N4), 6th gray level (N6) and 8th gray level (N8).

If the change of physical brightness between any two adjacent gray levels in the 2nd row is still small, then the gray levels in 2^{nd} row can be further extracted and shown on the 3rd row, which are the 1st gray level (N1) and the 5th gray level (N5), or other selected arrangements which are the 3rd gray level (N3) and the 7th gray level (N7), or 2nd gray level (N2) and the 6th gray level (N6), or 4th gray level (N4) and 8th gray level (N8). The purpose of this invention is enlarging change of grayness brightness to distinguish whether or not the brightness changes among interested gray levels are monochromatic.

### Achievement of the Invention

A preferred embodiment of this invention has been described in detail hereinabove. By using the above mentioned imaging generating means cooperated with either human eyes or equivalent visual system simulator, the effective number of gray levels for moving pictures of any interested LCD can be determined. Hereinabove is full of practical advances, uses, and values. Also, it is an invention never been disclosed in the market. Therefore, this invention is patentable for the application.

The foregoing description of the present invention has been presented for the purpose of illustration and description. As is understood by a person skilled in the art, the foregoing preferred embodiment of the present invention is illustrated of the present invention rather than limiting of the present invention. It is intended to cover various modifications and similar arrangements included within the spirit and scope of the appended claims, the scope of which should be accorded the broadest interpretation so as to encompass all such modifications and similar structure.

What is claimed is:

1. An effective number of gray levels detection apparatus is to determine the effective number of gray levels of a display while showing motion images, which detection apparatus comprising:
an image generation means for generating a still image and its duplication but with adjustable motion vectors, and then for providing an interested display to show the above-mentioned two images at the same time;
wherein the still image can present the gray level capability of the display while showing still images;
an examination means for determine the effective number of gray levels of the display while showing motion images from the above-mentioned motion image.

2. The apparatus as claim 1, wherein said gray levels of the still image are adjustable.

3. The apparatus as claim 1, wherein said the motion image is the duplication of the said still image but with adjustable moving speed and direction.

4. The apparatus as claim 3, wherein said the moving speed and direction of the moving image can be either automatically adjusted or by manually operated.

5. The apparatus as claim 1, wherein said the examined means can be either real human eyes or a human eyes simulator which simulates the detection behaviors of real human eyes.

6. A effective number of gray levels detection apparatus is to determine the effective number of gray levels of a display while showing motion images, which detection apparatus comprising:
a visual simulator for simulating visual detection and recognition; and
an image generation means for generating a still image and its duplication but with adjustable motion vectors, and then for providing an interested display to show the above-mentioned two images at the same time;
wherein the still image can present the gray level capability of the display while showing still images;
an examination means for determine the gray level capability of the display while showing motion images from the above-mentioned motion image which is a duplication of the still image.

7. The apparatus as claim 6, wherein said the visual simulator can be either a specified apparatus or a computer system with human eyes simulation programs.

8. The apparatus as claim 6, wherein said gray levels of the still image are adjustable.

9. The apparatus as claim 6, wherein said the motion image is the duplication of the said still image but with adjustable moving speed and direction.

10. The apparatus as claim 9, wherein said the moving speed and direction of the moving image can be either automatically adjusted or by manually operated.

11. An effective number of gray levels detection method is to determine the effective number of gray levels of a display while showing motion images, which detection method comprising:
Generating a still image and its duplication but with adjustable moving speed and direction, the duplication is referred as a motion image hereinafter, by an image generating means first, and then showing the images on the screen;
adjusting the moving speed and direction of the moving image; and
determining the discrimination of adjacent gray levels of the moving image.

12. The method as claim 11, wherein said the number of gray levels of a display while showing moving images is not lost if edge of adjacent gray levels of the moving image can be discriminated.

13. The method as claim 11, wherein said the number of gray levels of a display while showing moving images is lost if edge of adjacent gray levels of the moving image can not be discriminated.

14. The method as claim 11, wherein said the gray levels, moving speed, and moving direction are adjustable for detecting the gray level capability of the display while showing different moving pictures.

15. The method as claim 11, wherein said gray levels, speed and direction of the still image and the moving image can be either automatically adjusted or by manually operated.
